(19) United States
(12) Patent Application Publication
(10) Pub. No.: US 2023/0032459 A1
(43) Pub. Date: Feb. 2, 2023

(54) METHOD FOR ACTIVATING A CATALYTICALLY ACTIVE MATERIAL

(71) Applicant: TOPSOE A/S, Kgs. Lyngby (DK)

(72) Inventors: Christian Frederik WEISE, Ballerup (DK); Michal LUTECKI, København Ø (DK); Frank Bartnik JOHANSSON, Roskilde (DK)

(73) Assignee: TOPSOE A/S, Kgs. Lyngby (DK)

(21) Appl. No.: 17/786,983

(22) PCT Filed: Dec. 17, 2020
(86) PCT No.: PCT/EP2020/086782

§ 371 Date: Jun. 17, 2022

(30) Foreign Application Priority Data
Dec. 20, 2019 (DK) PA 2019 01527

(51) Int. Cl. B01J 38/66; B01J 23/28; B01J 23/30; B01J 23/75; B01J 23/755; B01J 23/84; B01J 23/92; B01J 23/94; B01J 37/02; B01J 37/08; B01J 37/00

(52) U.S. Cl. CPC B01J 38/66; B01J 23/28; B01J 23/30; B01J 23/75; B01J 23/84; B01J 23/92; B01J 23/94; B01J 23/755; B01J 37/08; B01J 37/0018; B01J 37/0203

(57) ABSTRACT

A method for activating an oxidic fresh hydroprocessing catalyst or the catalytically active material of a spent hydroprocessing catalyst comprising a refractory oxide support and one or more base metals selected from Ni, Co, Mo and W comprises optionally regenerating the catalyst, adjusting an aqueous activating solution, which contains an organic acid, to pH > 3 with an alkaline additive, impregnating the catalytically active material with the pH-adjusted aqueous activating solution, and heat-treating the catalyst at a temperature of 120-450° C.

The present invention concerns a method for activating a hydrotreating catalyst or a hydroprocessing catalyst. The hydrotreating catalyst to be activated may be either a fresh hydrotreating catalyst or a hydrotreating catalyst, which has been used and subsequently regenerated. The present invention also pertains to the hydrotreating catalyst obtainable by said process and to its use in hydrotreating. In addition, the present invention relates to similar processes applied to other hydroprocessing catalysts, such as isomerization and hydrocracking catalysts, and such resulting catalysts.

In general, the object of catalytically hydrotreating hydrocarbon-containing feeds is the removal of impurities. Common impurities are sulfur compounds and nitrogen compounds. The at least partial removal of such impurities from a feed will ensure that, once the final product has been burned, fewer sulfur oxides and/or nitrogen oxides harmful to the environment will be released. In addition, sulfur compounds and nitrogen compounds are toxic to many of the catalysts employed in the refining industry for converting feeds into ready-for-use products. Examples of such catalysts include cracking catalysts, hydrocracking catalysts, and reforming catalysts. It is therefore customary for feeds to be subjected to a catalytic hydrotreatment prior to being processed in, e.g., a cracking unit. Catalytic hydrotreatment implies contacting a feed with hydrogen at elevated temperature and pressure in the presence of a hydrotreating catalyst. In this process, the sulfur compounds and nitrogen compounds present in the feed are converted into readily removable hydrogen sulfide and ammonia.

In general, hydrotreating catalysts comprise a carrier with a Group VI metal component and a Group VIII metal component deposited thereon. The most commonly employed Group VI metals are molybdenum and tungsten, while cobalt and nickel are the conventional Group VIII metals. Phosphorus and other elements may also be present in the catalyst. The prior art processes for preparing these catalysts are characterized in that a carrier material is composited with hydrogenation metal components, for example by impregnation, after which the composite is calcined to convert the metal components into their oxides. Before being used in hydrotreating, the catalysts are generally pre-sulfided to convert the hydrogenation metals into their sulfides.

After 2-3 years of service, hydrotreating catalysts will either be sent to reclaim of the metals or undergo a process of regeneration and rejuvenation with the purpose of restoring most of their initial activity. A lower activity of a regenerated catalyst is due to sintering of metals in the regeneration process or during use, resulting in a low dispersion of the active phase. This, in turn, yields a lower activity compared to the activity of the fresh catalyst.

Thus, in the method of the present invention, most of the lost activity is restored by treating the catalyst with a solution containing an organic acid and a base to redistribute the metals after regeneration.

In addition to regeneration of hydrotreatment catalysts, the present invention relates to similar processes applied to other hydroprocessing catalysts, such as isomerization and hydrocracking catalysts, and such resulting catalysts.

The rejuvenation methods utilizing organic acids, which are described in the literature, do not address the problem of loss-on-attrition (LOA, as measured according to standard ASTM D4058-96) which is a state of physical instability occurring when the acid is contacted with the alumina carrier of a hydrotreating catalyst. When regenerated, alumina-based catalysts are treated with pure organic acids, a high LOA is observed due to corrosion/dissolution of the surface of the carrier.

US 7,956,000 B2 describes a process for activating a hydrotreating catalyst comprising a group VIB metal oxide and a group VIII metal oxide. The process comprises contacting the catalyst with an acid and an organic additive having a boiling point in the range of 80-500° C. and a solubility in water of at least 5 g per liter (20° C., atm. pressure), optionally followed by drying under such conditions that at least 50% of the additive is maintained in the catalyst. The hydrotreating catalyst may be fresh, or it may be a used catalyst, which has been regenerated.

It has now turned out that the process described in the above-cited reference can be improved if the catalyst is activated with the combination of an organic acid and an alkaline additive.

Accordingly, the present invention relates to a method for activating an oxidic fresh catalyst or the catalytically active material of a spent catalyst comprising a refractory oxide support and one or more base metals taken from the group comprising nickel, cobalt, molybdenum and tungsten, said method comprising the steps of:
optionally regenerating the catalyst,
adjusting an aqueous activating solution, which contains an organic acid, to pH > 3 with an alkaline additive,
impregnating the regenerated catalyst with the pH-adjusted aqueous activating solution, and
heat-treating the catalyst at a temperature of 120-450° C.

The step of regenerating the catalyst involves removal of deposits, especially combustible deposits, e.g. by thermal oxidation in the presence of oxygen.

The step of adjusting an aqueous activating solution, which contains an organic acid, to a target pH value being above 3 with an alkaline additive, may also be carried out by addition of an amount of an aqueous solution containing an organic acid and addition of an amount of an alkaline additive in two or more steps, wherein the mixing of the amount of an aqueous solution containing an organic acid and the amount of an alkaline additive would have resulted in a solution having pH>3. If the catalyst or catalytically active material is contacted with aqueous solution containing an organic acid prior to the contact with an amount of alkaline or basic additive, the period and/or temperature should be limited to avoid damaging the support.

Since a fresh catalyst does not need to be regenerated, the optional step of regenerating the catalyst is only included when the catalytic material is a used (i.e. spent) catalyst.

The acid used in the aqueous activating solution preferably contains at least one hydroxyl group.

The target pH value of the aqueous activating solution preferably is between 4 and 7.

As regards the base metals, these are present in amounts as follows: Ni, Co: 1-10 wt% and Mo, W: 5-30 wt%.

The standard solution within the field of the invention has been to use a single organic acid in order to obtain the desired regain of activity. This, however, often results in a substantial LOA.

By adjusting the activation solution to pH > 3, preferably to 4 < pH < 7, the problem concerning dissolution of the catalyst carrier is mitigated. This can easily be done in existing factory or plant settings, implying only minor changes to the procedure already applied.

In the absence of pH adjustments, the originally acidic activating solution is aggressive towards alkaline alumina carriers, which are commonly used in hydrotreating catalysts, and it will cause dissolution of the carriers. This dissolution causes a deterioration of the mechanical stability of the catalyst, resulting in dust formation and/or an increased LOA.

In the industrially regenerated, spent catalysts to be activated according to the invention, coke and sulfur is burned off in a controlled manner to form metal oxides.

The catalyst carrier may comprise the conventional refractory oxides, e.g., alumina, silica, silica-alumina, alumina with silica-alumina dispersed therein, silica-coated alumina, magnesia, zirconia, boria and titania, as well as mixtures of these oxides. As a rule, preference is given to the carrier being of alumina, silica-alumina, alumina with silica-alumina dispersed therein or silica-coated alumina. Special preference is given to alumina and alumina containing up to 10 wt% of silica. A carrier containing a transition alumina, for example an eta, theta or gamma-alumina, is preferred within this group, wherein a gamma-alumina carrier is most especially preferred.

Basic inorganic additives to adjust pH can be ammonia or be selected from the group of inorganic metal salts of hydroxides, carbonates, bicarbonates, oxides and phosphates, e.g. LiOH, KOH, NaOH, NH₃, Ca(OH)₂, Mg(OH)₂ and basic Co, Ni and Mo compounds, such as carbonates, hydroxides and hydroxy-carbonates of Co and Ni as well as ammonium molybdates, ammonium metatungstate. Addition of metal salts of the active metals has the benefit of increasing the catalyst activity and may also be carried out by addition of other Co, Ni, Mo and W compounds such as nitrates, in the same step, or independently of addition of acid and base.

The pore volume of the catalyst (measured via mercury penetration, contact angle 140 degrees, surface tension of 480 dyn/cm) is not critical to the method according to the invention and will generally be in the range of 0.2-2 ml/g, preferably 0.4-1 ml/g. The specific surface area is not critical to the method according to the invention either, and it will generally be in the range of 50-400 m²/g(as measured using the BET method). Preferably, the catalyst will have a median pore diameter in the range of 6-15 nm, as determined by mercury porosimetry, and at least 60 percent of the total pore volume will be in the range of ± 3 nm from the median pore diameter and below a pore radius of 250 Å (50 nm diameter) .

Drying of the catalyst may e.g. be carried out in air, under vacuum, or in inert gas. Generally, it is advantageous to use a drying temperature below 220° C., although a higher or lower temperature may be necessary to promote or avoid reactions during drying.

In one embodiment, a basic additive is added to the starting material in a first step, optionally followed by drying under such conditions that at least 50 percent of the added additive remains in the catalyst. Then, the resulting material is contacted with a solution of an organic acid, optionally followed by drying under such conditions that at least 50 percent of the alkaline additive and/or organic acid remains in the catalyst.

The advantage of incorporating the acid and the additive into the catalyst in separate steps is that the properties of the impregnation solutions may be tailored to meet the requirements of the acid and the additive. Nevertheless, for reasons of efficiency, it is preferred to contact the starting catalyst with a single impregnation solution comprising both the acid and the additive, optionally followed by a drying/calcining step under such conditions that at least 50 percent of the additive remains in the catalyst.

In the context of the invention, an organic acid is defined as a compound comprising at least one carboxylic group (COOH). The organic acid is preferably a carboxylic acid comprising at least one carboxyl group and 6 or fewer carbon atoms including the carbon atoms in the carboxyl group(s). The suitable acids include 2-hydroxyethanoic acid, 2-hydroxypropane-1,2,3-tricarboxylic acid, 2-hydroxy-butanedioic acid, 2-hydroxypropionic acid, 3-hydroxypropionic acid, 2-, 3- and 4-hydroxybutanoic acid, 2-, 3-, 4-, 5- and 6-hydroxyhexanoic acid, 2,3-dihydroxybutanedioic, 2,3-dihydroxypropanoic acid, 2,3,4,5,6-pentahydroxyhexanoic acid, poly-lactic acid and (5R)-[(1S)-1,2-dihydroxyethyl]-3,4-dihydroxyfuran-2(5H)-one. In addition, generally, organic acids with 4 or fewer carbon atoms are preferred.

The boiling point of the acid is preferably in the range of 100-400° C., more preferably 150-350° C. The boiling point of the acid is balanced between on the one hand the desire that the acid remains on the catalyst during the preparation process, including the drying step, and on the other hand the need for the acid to be removed from the catalyst during catalyst use or sulfidation. In case the organic acid has no boiling point but instead decomposes in the specified temperature range, the term boiling point is meant to be synonymous with the decomposition temperature.

The heat-treated acid and additive-containing hydrotreating catalyst of the present invention may be subjected to a sulfiding step before it is used in the hydrotreating of hydrocarbon feeds, but - as has been explained before -this is not necessary. If it is decided to sulfide the catalyst before use, this can be done in one of the ways known in the art.

For example, it is possible to contact the catalyst with inorganic or organic sulfur compounds, such as hydrogen sulfide, elemental sulfur or organic polysulfides, or to sulfide the catalyst by contacting it with a hydrocarbon feed to which a sulfur compound has been added.

As indicated above, the catalyst to be activated in the method according to the invention is either a fresh hydrotreating catalyst or a used and subsequently regenerated hydrotreating catalyst.

The fresh oxidic hydrotreating catalyst suitable for use as starting material in the method of the invention are known in the art. They may be obtained, e.g., as follows. A carrier precursor is prepared, e.g., in the case of alumina, in the form of an alumina hydrogel (boehmite). After it has been dried, e.g. by means of spray drying, it is shaped into particles, for example by extrusion. Then the shaped particles are calcined at a temperature in the range of 400-850° C., resulting, in the case of alumina, in a carrier containing a transition alumina, e.g. a gamma-, theta- or eta-alumina. Then, suitable amounts of precursors for the hydrogenation metals and the optional other components, such as phosphorus, are deposited on the catalyst, e.g. in the form of an aqueous solution.

In the case of Group VI metals and Group VIII metals, the precursors may be ammonium molybdate, ammonium tungstenate, cobalt nitrate and/or nickel nitrate. Suitable phosphorus component precursors include phosphoric acid and the various ammonium hydrogen phosphates. After an optional drying step at a temperature in the range of 25-200° C., the resulting material is calcined at a temperature in the range of 350-750° C., in particular 425-600° C., to convert all metal component precursors, and the optional other component precursors, to form oxide components.

The activation process of the present invention is also applicable to the catalyst, which has been used in the hydrotreating of hydrocarbon feeds and later regenerated.

The regeneration step of the process according to the invention is carried out by contacting the used additive-based catalyst with an oxygen-containing gas under such conditions that, after regeneration, the carbon content of the catalyst generally is below 3 wt%, preferably below 2 wt%, more preferably below 1 wt%. After regeneration, the sulfur content of the catalyst generally is below 2 wt%, preferably below 1 wt%. Before the regeneration step, the carbon content of the catalyst generally is above 5 wt%, typically between 5 and 25 wt%. The sulfur content of the catalyst before the regeneration step generally is above 5 wt%, typically between 5 and 20 wt%.

It is preferred for the regeneration step in the presence of oxygen to be carried out in two steps, namely a first lower-temperature step and a second higher-temperature step. In the first lower-temperature step, the catalyst is contacted with an oxygen-containing gas at a temperature of 100-370° C., preferably 175-370° C. In the second higher-temperature regeneration step, the catalyst is contacted with an oxygen-containing gas at a temperature of 300-650° C., preferably 320-550° C., still more preferably 350-525° C. The temperature during the second step is higher than the temperature of the first step discussed above, preferably by at least 10° C., more preferably by at least 20° C. The determination of appropriate temperature ranges is well within the scope of the skilled person, taking the above indications into account.

It is preferred for the catalyst to be regenerated in a moving bed process, preferably - if applicable - at a bed thickness of 1-15 cm. In the context of the present specification, the term "moving bed" is intended to refer to all processes wherein the catalyst is in movement as compared to the unit, including ebullated bed processes, fluidized processes, processes in which the catalyst is rotated through a unit, and all other processes wherein the catalyst is in movement.

The duration of the regeneration process including stripping will depend on the properties of the catalyst and the exact way in which the process is carried out, but it will generally be between 0.25 and 24 hours, preferably between 2 and 16 hours.

The regenerated catalyst will be contacted with the acid and additive in the process according to the invention as has been described above.

The invention is illustrated in more detail in the below example:

### EXAMPLE

Two cases are described: In both cases, an industrially regenerated TK-609 HyBRIM™ sample was used, and the LOA of the starting material was 0.3 wt%.

In the first case, the regenerated catalyst was treated with 5.5 M 2-hydroxyethanoic acid, pH 1.12, followed by drying at 190° C. for 2 hours. This treatment resulted in an LOA of 8.7 wt%.

In the second case, the regenerated catalyst was treated with 5.5 M 2-hydroxyethanoic acid and 4.6 M NH₃, pH 4.86, followed by drying at 190° C. for 2 hours. This treatment resulted in an LOA of only 0.4 wt%.

1. A method for activating an oxidic fresh hydroprocessing catalyst or the catalytically active material of a spent hydroprocessing catalyst comprising a refractory oxide support and one or more base metals taken from the group comprising nickel, cobalt, molybdenum and tungsten, said method comprising the steps of:
optionally regenerating the catalyst,
providing one or more activating solutions containing an organic acid and an alkaline additive, in amounts equivalent to an aqueous activating solution having a target pH higher than 3,
impregnating the catalytically active material with the one or more aqueous activating solution(s), and
heat-treating the catalyst at a temperature of 120-450° C.

2. Method according to claim 1, wherein the organic acid in the aqueous activating solution has 6 or fewer carbon atoms.

3. Method according to claim 1, wherein the aqueous activating solution also contains an organic acid with a hydroxyl group.

4. Method according to claim 1, wherein pH of the aqueous activating solution is 4 < pH < 7.

5. Method according to claim 1, wherein the catalyst is heat treated at a temperature of 120-220° C.

6. Method according to claim 1, wherein the catalyst is heat treated at a temperature of 350-450° C.

7. Method according to claim 1, wherein the organic acid is selected from 2-hydroxyethanoic acid, 2-hydroxypropane-1,2,3-tricarboxylic acid, 2-hydroxybutanedioic acid, 2-hydroxypropionic acid, 3-hydroxypropionic acid, 2-, 3- and 4-hydroxybutanoic acid, 2-, 3-, 4-, 5- and 6-hydroxyhexanoic acid, 2,3-dihydroxybutanedioic, 2,3-dihydroxypropanoic acid, 2,3,4,5,6-pentahydroxyhexanoic acid, polylactic acid and (5R)-[(1S)-1,2-dihydroxyethyl]-3,4-dihydroxyfuran-2(5H)-one.

8. Method according to claim 1, wherein the alkaline additive is inorganic.

9. Method according to claim 8, wherein the alkaline inorganic additive is ammonia.
